(19) United States
(12) Patent Application Publication
(10) Pub. No.: US 2022/0393197 A1
(43) Pub. Date: Dec. 8, 2022

(54) FUEL CELL POWER GENERATION MODULE

(71) Applicants: Hyundai Motor Company, Seoul (KR); Kia Corporation, Seoul (KR)

(72) Inventor: Sung Weon SONG, Hwaseong-si (KR)

(73) Assignees: Hyundai Motor Company, Seoul (KR); Kia Corporation, Seoul (KR)

(21) Appl. No.: 17/692,542

(22) Filed: Mar. 11, 2022

(30) Foreign Application Priority Data
Jun. 8, 2021 (KR) 10-2021-0074011

(51) Int. Cl. H01M 8/04858; H01M 8/04007

(52) U.S. Cl. CPC H01M 8/0494; H01M 8/04074

(57) ABSTRACT

A fuel cell power generation module includes a lower frame configured to surround a lower portion of a power module complete (PMC) and to support and fix a side portion of the PMC so as to secure a space below the PMC, an upper frame coupled to an upper portion of the lower frame and configured to surround the PMC from above, and a plurality of side panels disposed to allow an electric module and a cooling module to be mounted on different side surfaces of the upper frame.

### CROSS REFERENCE TO RELATED APPLICATION

The present application claims priority of Korean Patent Application No. 10-2021-0074011, filed on Jun. 8, 2021 in the Korean Intellectual Property Office, the entire contents of which is incorporated herein for all purposes by reference.

### TECHNICAL FIELD

The present disclosure relates to a technology of a power generation module using a fuel cell system.

### BACKGROUND

In Fuel cell vehicles, fuel cell systems are mounted on the vehicles, and driving motors are driven due to electricity generated in the fuel cell systems so that fuel cell vehicles travel.

The fuel cell system includes a fuel cell stack, a power module complete (PMC) which is an integrated module for generating electric energy including a driving device, various filters, cooling parts, and electric parts.

The above described fuel cell system, which is designed and manufactured to be mounted on a vehicle, may be mounted on a vehicle as well as utilized as a component module of a power generation facility.

In particular, even fuel cell systems, which have already reached the end of their lifespan for vehicles, often retain power generation capabilities as power generation facilities. Therefore, it is preferable to utilize the fuel cell systems as component modules of the power generation facilities, thereby fully utilizing the remaining capacities of the fuel cell systems.

The information disclosed in the Background section above is to aid in the understanding of the background of the present disclosure, and should not be taken as acknowledgement that this information forms any part of prior art.

### SUMMARY

Accordingly, the present disclosure has been made keeping in mind the above problems occurring in the related art, and the present disclosure is intended to propose a fuel cell power generation module which allows a fuel cell system for a vehicle to be used to form a power generation facility, thereby allowing the remaining power generation capability of the fuel cell system to be maximally utilized and allowing a plurality of fuel cell systems to easily and efficiently build a large-scale power generation facility.

According to one aspect, there is provided a fuel cell power generation module including a lower frame configured to surround a lower portion of a power module complete (PMC) and to support and fix a side of the PMC so as to secure a space below the PMC, an upper frame coupled to an upper portion of the lower frame and configured to surround the PMC from above, and a plurality of side panels disposed to allow an electric module and a cooling module to be mounted on different side surfaces of the upper frame.

The upper frame and the lower frame may be configured in a hexahedron shape in a state in which the upper frame and the lower frame are coupled to each other, so as to accommodate the PMC, an electric module, a filter module, and a cooling module.

The lower frame may include four lower columns respectively disposed at four corners of the lower frame, which define the hexahedron shape, upper ends of the four lower columns may be connected and fixed to each other by a plurality of support rods, and the PMC may be supported on and fixed to the lower frame by a plurality of PMC brackets respectively protruding from the plurality of support rods toward the PMC.

The upper frame may include four upper columns respectively aligned with the four lower columns and disposed at four corners of the upper frame, which define the hexahedron shape, upper ends of the four upper columns may be connected and fixed to each other by a plurality of upper rods, and a plurality of middle rods are connected by being spaced downward in parallel to the plurality of upper rods between the four upper columns.

The plurality of side panels may be respectively fixed to the side surfaces of the upper frame each defined by the respective middle rod, the respective upper rod, and the respective upper column.

Each of the plurality of side panels may include a plurality of engagement holes defined on an upper portion and a lower portion thereof to be engaged with the respective middle rod and the respective upper rod, and each of the engagement holes may be defined as an elongated hole elongated in a length direction of the respective middle rod and the respective upper rod.

One or more among a fuse box in which various fuses and various relays are installed, a blower power control unit (BPCU), and a fuel cell control unit (FCU) may be installed in at least one of the plurality of side panels for mounting the electric module.

In a state in which a box cover of the fuse box is exposed to an outside, an access hole may be included in each of the plurality of side panels for mounting the electric module to allow the fuse box to be fixed and to allow the box cover to be detached from the fuse box.

A filter module may be installed in another side surface of the upper frame by a filter bracket, and the filter module may be installed to allow the filter cover to be exposed toward an outer surface of the upper frame so as to allow the filter cover to be detached from an outside of the upper frame.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a diagram for describing a process of assembling an upper frame and a lower frame of a fuel cell power generation module according to the present disclosure;

FIG. 2 is a conceptual diagram illustrating a state of the fuel cell power generation module assembled as shown in FIG. 1 when viewed from the top;

FIG. 3 is a diagram for describing the concept of stacking the fuel cell power generation module assembled as shown in FIG. 1;

FIG. 4 is a side view of the fuel cell power generation module of FIG. 1 that illustrates a side surface on which an electric module is installed;

FIG. 5 is an observation view in a V-direction of FIG. 4;

FIG. 6 is a detailed diagram illustrating a side panel on which the electric module of FIG. 4 is mounted;

FIG. 7 is a three-dimensional view of FIG. 6;

FIG. 8 is a side view of the fuel cell power generation module of FIG. 1 that illustrates a side surface on which a filter module is installed;

FIG. 9 is an observation view in an IX-direction of FIG. 8; and

FIG. 10 is a detailed diagram illustrating a portion in which the filter module of FIG. 8 is mounted.

### DETAILED DESCRIPTION OF THE INVENTION

Specific structural and functional descriptions of the embodiments of the present disclosure disclosed in this disclosure or application are illustrative only for the purpose of describing the embodiments, and the embodiments according to the present disclosure may be implemented in various forms and should not be construed as being limited to embodiments described in this disclosure or application.

The embodiments according to the present disclosure may be variously modified and may have various forms, so that specific embodiments will be illustrated in the drawings and be described in detail in this disclosure or application. It should be understood, however, that it is not intended to limit the embodiments according to the concept of the present disclosure to specific disclosure forms, but it includes all modifications, equivalents, and alternatives falling within the spirit and technical scope of the present disclosure.

The terms first, second, and/or the like may be used to describe various components, but the components should not be limited by these terms. These terms may be used only for the purpose of distinguishing one component from another component, and, for example, a first component may be referred to as a second element, and similarly, the second component may also be referred to as the first component without departing from the scope of the present disclosure.

When a component is referred to as being “connected,” or “coupled” to another component, the component may be directly connected or coupled to another component, but it should be understood that still another component may exist between the component and another component. On the contrary, when a component is referred to as being “directly connected” or “directly coupled” to another component, it should be understood that still another component may not be present between the component and another component. Other expressions describing the relationship between components, that is, “between” and “immediately between,” or “adjacent to” and “directly adjacent to” should also be construed as described above.

Terms used herein is used only for the purpose of describing specific embodiments, and are not intended to limit the present disclosure. Unless the context clearly dictates otherwise, the singular form includes the plural form. In this disclosure, the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

Unless defined otherwise, all terms including technical or scientific terms used herein have the same meaning as commonly understood by those skilled in the art to which the present disclosure pertains. General terms that are defined in a dictionary shall be construed to have meanings that are consistent in the context of the relevant art, and will not be interpreted as having an idealistic or excessively formalistic meaning unless clearly defined in this disclosure.

Hereinafter, exemplary embodiments of the present disclosure will be described in detail with reference to the accompanying drawings. Like reference numerals denote like members throughout the drawings.

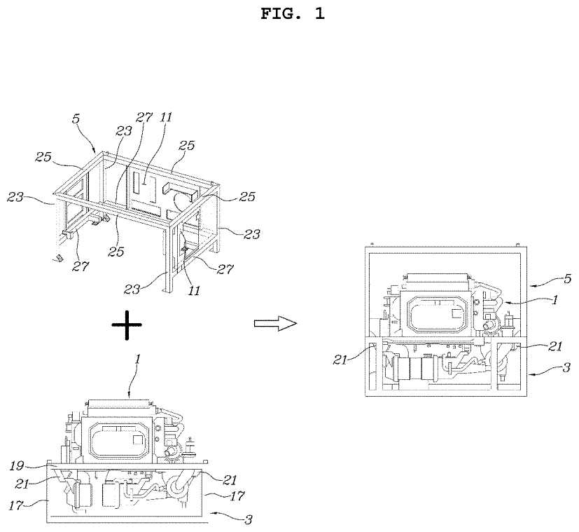

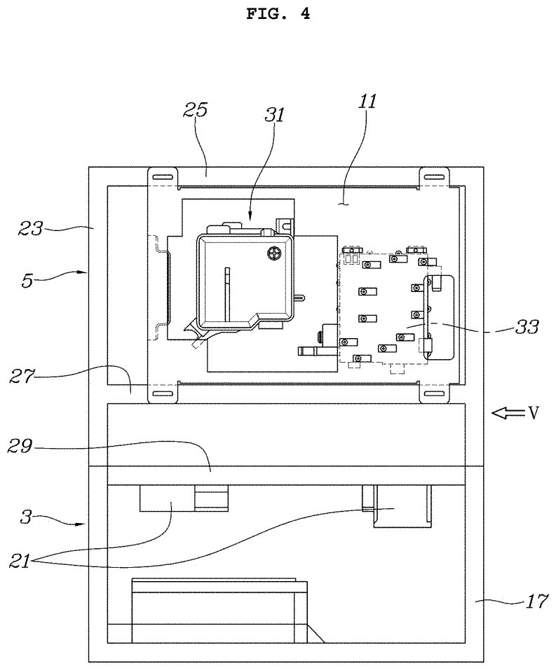

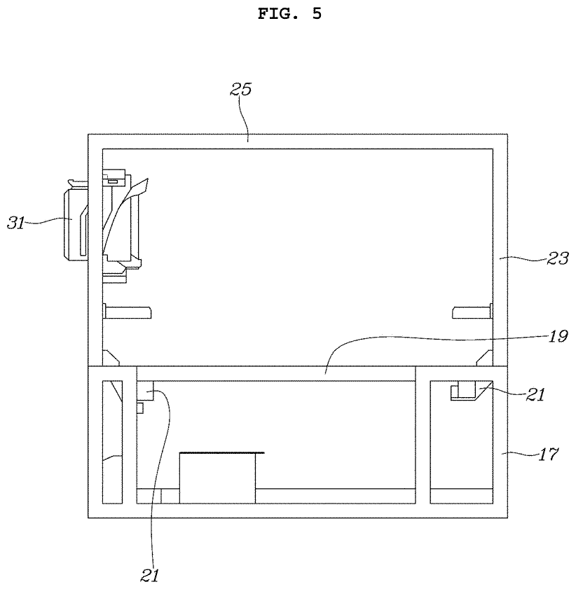

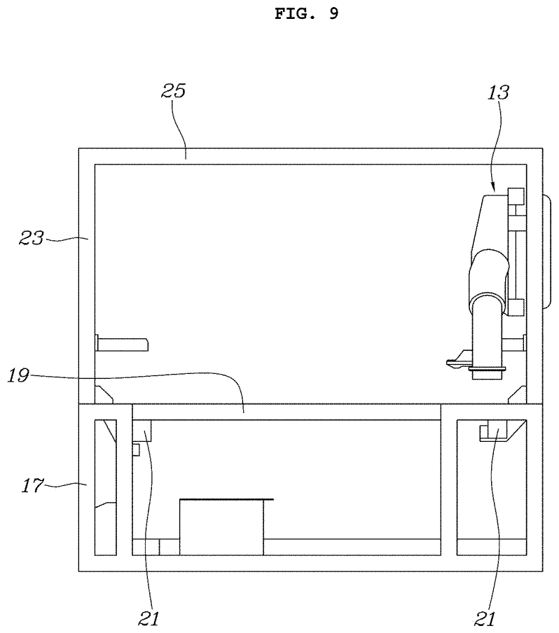

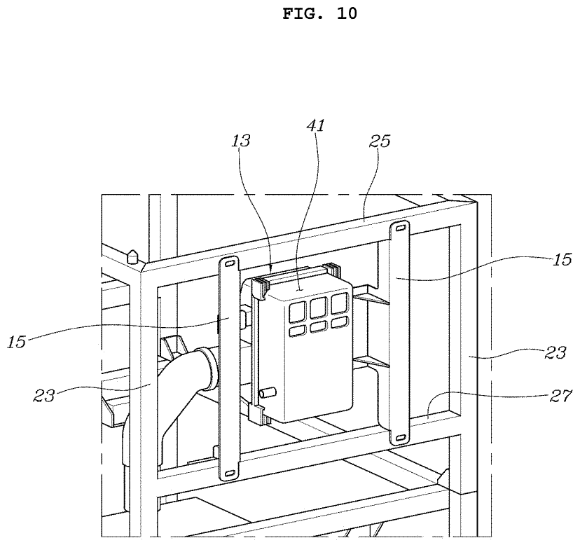

Referring to FIGS. 1 to 10, a fuel cell power generation module according to an exemplary embodiment of the present disclosure includes a lower frame 3 configured to surround a lower portion of a power module complete (PMC) 1 and tp support and fix a side portion of the PMC 1 so as to secure a space below the PMC 1, an upper frame 5 coupled to an upper portion of the lower frame 3 and configured to surround the PMC 1 from above, and a plurality of side panels 11 disposed to allow an electric module 7 and a cooling module 9 to be mounted on different side surfaces of the upper frame 5.

In addition, a filter module 13 is installed on another side surface of the upper frame 5 by a filter bracket 15.

That is, the fuel cell power generation module of the present disclosure is arranged such that the PMC 1 is disposed in a central portion of an inner space formed by the upper frame 5 and the lower frame 3 and, as shown in the FIG. 2, the electric module 7, the cooling module 9, and the filter module 13 are disposed inside the upper frame 5 based on the PMC 1.

Therefore, in the fuel cell power generation module of the present disclosure, the PMC 1, the electric module 7, the cooling module 9, and the filter module 13, which constitute a fuel cell system, are modularized in a state of being surrounded by the upper frame 5 and the lower frame 3, and thus a plurality of power generation modules may be easily integrated so that power generation facilities of various scales may be easily configured.

In the present embodiment, in a state in which the upper frame 5 and the lower frame 3 are coupled, a structure is formed as a hexahedron shape which accommodates the PMC 1, the electric module 7, the filter module 13, and the cooling module 9.

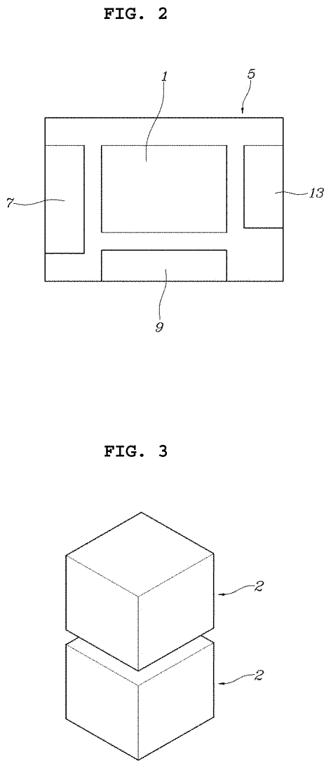

Therefore, as shown in FIG. 3, similar to stacking hexahedral boxes, it is easy to implement a multi-layered arrangement structure in which a plurality of power generation modules are vertically disposed to be adjacent to each other so that a density of power generation facilities may be increased to minimize an occupied area and a space.

For reference, in FIG. 3, the fuel cell power generation module formed by the present disclosure is indicated by a reference numeral 2.

The lower frame 3 includes four lower columns 17 disposed at four corners defining the hexahedron shape, and upper ends of the four lower columns 17 are connected and fixed to each other by a plurality of support rods 19. The PMC 1 has a structure which is supported on and fixed to the lower frame 3 by a plurality of PMC brackets 21 protruding from the support rods 19 toward the PMC 1.

Therefore, in a state in which the PMC 1 is supported on and fixed to the lower frame 3, a space below the PMC 1 is secured so that accessibility for various repairs or maintenance may be provided to easily perform cooling and easily check and respond to leakage of cooling water.

The upper frame 5 includes four upper columns 23 aligned with the four lower columns 17 and disposed at four corners defining the hexahedron shape, and upper ends of the four upper columns 23 are connected and fixed to each other by a plurality of upper rods 25. Thus, a structure is formed such that a plurality of middle rods 27 are spaced downward in parallel to the upper rods 25 and are connected between the upper columns 23.

In addition, the side panel 11 is fixed to a side surface formed by the middle rod 27, the upper rod 25, and the upper column 23.

In the present embodiment, a plurality of engagement holes 29 are defined on upper and lower portions of the side panel 11 to be engaged with the middle rods 27 and the upper rods 25. Each of the engagement holes 29 is defined as an elongated hole elongated in a length direction of the middle rod 27 and the upper rod 25, and thus each of the engagement holes 29 is formed in a structure of which a position is flexibly changed and is capable of responding to when a wiring harness is connected to an electric component.

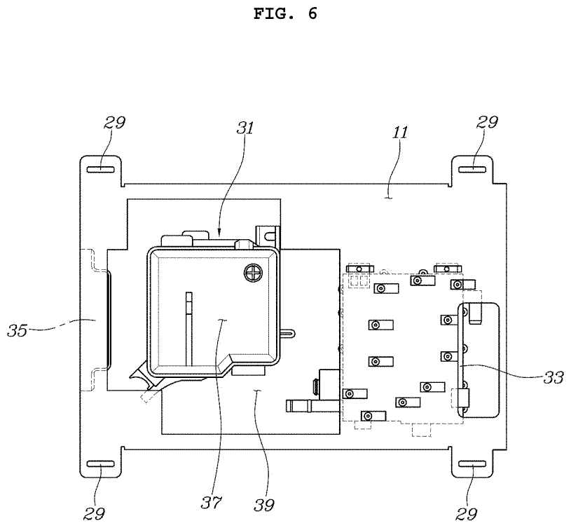

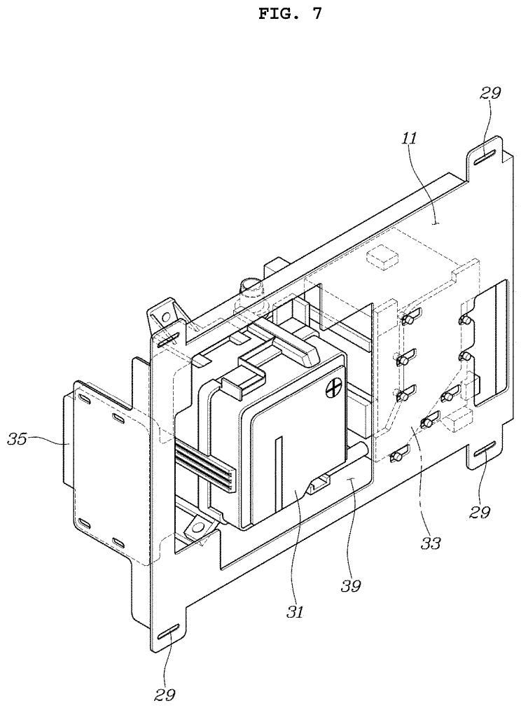

One or more among a fuse box 31 in which various fuses and various relays are installed, a blower power control unit (BPCU) 33, and a fuel cell control unit (FCU) 35 may be installed in the side panel 11 for mounting the electric module 7, and FIGS. 6 and 7 illustrate an example in which all of the fuse box 31, the BPCU 33, and the FCU 35 are mounted.

In particular, a configuration is formed such that, in a state in which the box cover 37 of the fuse box 31 is exposed to the outside, an access hole 39 is included in the side panel 11 for mounting the electric module 7 to allow the fuse box 31 to be fixed and to allow the box cover 37 to be easily detached from the fuse box 31.

Thus, according to the present disclosure, the box cover 37 of the fuse box 31 is capable of being easily opened from a side of the upper frame 5 and necessary maintenance is capable of being performed so that the present disclosure is very advantageous for maintenance.

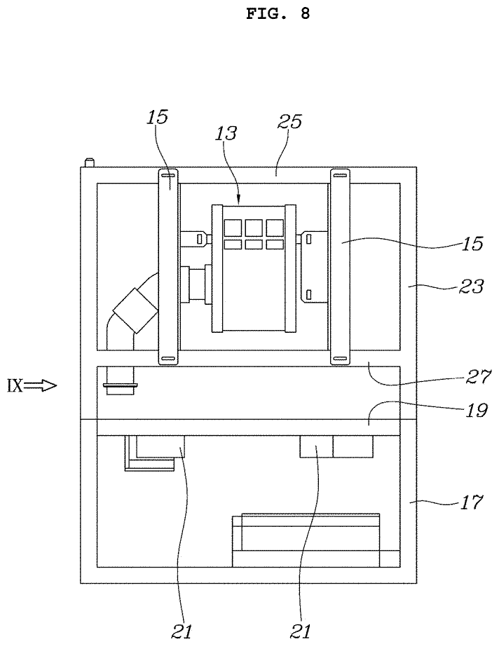

In addition, as shown in FIGS. 8 to 10, the filter module 13 is installed on another side surface of the upper frame 5 by the filter bracket 15, and the filter module 13 is installed to allow a filter cover 41 to be exposed toward an outer surface of the upper frame 5 so as to allow the filter cover 41 to be easily detached from the outside of the upper frame 5.

Therefore, simplification in workability of opening the filter cover 41 and replacing a filter is secured.

In accordance with the present disclosure, a power generation facility can be configured by integrating fuel cell power generation modules using a fuel cell system for a vehicle so that the remaining power generation capability of the fuel cell system can be maximally utilized, and thus power generation facilities from a small scale to a large scale can be easily and efficiently expanded and constructed by combining a plurality of fuel cell power generation modules.

In addition, when the power generation facility is constructed, a multi-layered arrangement of the fuel cell power generation modules is possible so that an occupied area of the power generation facility can be minimized due to integration of the power generation facility, and maintenance of the fuel cell power generation module can be easily performed.

Although specific embodiments of the present disclosure have been described and illustrated, those skilled in the art will appreciate that various alternations and modifications are possible without departing from the technical spirit of the present disclosure as disclosed in the appended claims.

What is claimed is:

1. A fuel cell power generation module, comprising:
a lower frame configured to surround a lower portion of a power module complete (PMC) and to support and fix a side portion of the PMC so as to secure a space below the PMC;
an upper frame coupled to an upper portion of the lower frame and configured to surround the PMC from above; and
a plurality of side panels disposed to allow an electric module and a cooling module to be mounted on different side surfaces of the upper frame.

2. The fuel cell power generation module of claim 1, wherein the upper frame and the lower frame are configured in a hexahedron shape in a state in which the upper frame and the lower frame are coupled to each other so as to accommodate the PMC, the electric module, a filter module, and the cooling module.

3. The fuel cell power generation module of claim 2, wherein:
the lower frame includes four lower columns respectively disposed at four corners of the lower frame, which define the hexahedron shape;
upper ends of the four lower columns are connected and fixed to each other by a plurality of support rods; and
the PMC is supported on and fixed to the lower frame by a plurality of PMC brackets protruding from the plurality of support rods, respectively, toward the PMC.

4. The fuel cell power generation module of claim 3, wherein:
the upper frame includes four upper columns respectively aligned with the four lower columns and disposed at four corners of the upper frame, which define the hexahedron shape;
upper ends of the four upper columns are connected and fixed to each other by a plurality of upper rods; and
a plurality of middle rods are connected by being spaced downward in parallel to the plurality of upper rods between the four upper columns.

5. The fuel cell power generation module of claim 4, wherein the plurality of side panels are respectively fixed to the side surfaces of the upper frame each defined by the respective middle rod, the respective upper rod, and the respective upper column.

6. The fuel cell power generation module of claim 5, wherein:
each of the plurality of side panels includes a plurality of engagement holes defined on an upper portion and a lower portion thereof to be engaged with the respective middle rod and the respective upper rod; and
each of the engagement holes is defined as an elongated hole elongated in a length direction of the respective middle rod and the respective upper rod.

7. The fuel cell power generation module of claim 1, wherein one or more among a fuse box in which various fuses and various relays are installed, a blower power control unit (BPCU), and a fuel cell control unit (FCU) are installed in at least one of the plurality of side panels for mounting the electric module.

8. The fuel cell power generation module of claim 7, wherein, in a state in which a box cover of the fuse box is exposed to an outside, an access hole is included in the plurality of side panels for mounting the electric module to allow the fuse box to be fixed and to allow the box cover to be detached from the fuse box.

9. The fuel cell power generation module of claim 1, wherein:
a filter module is installed on another side surface of the upper frame by a filter bracket; and
the filter module is installed to allow a filter cover to be exposed toward an outer surface of the upper frame so as to allow the filter cover to be detached from an outside of the upper frame.
